(19) United States
(12) Patent Application Publication
(10) Pub. No.: US 2009/0282068 A1
(43) Pub. Date: Nov. 12, 2009

(54) SEMANTIC PACKAGER

(76) Inventors: John J. Shockro, North Attleboro, MA (US); Jean-Marie R. Dautelle, St. Remy-les-Chevreuses (FR)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/432,931

(22) Filed: Apr. 30, 2009

Related U.S. Application Data
(60) Provisional application No. 61/052,349, filed on May 12, 2008.

(51) Int. Cl. G06F 17/30

(52) U.S. Cl. 707/101; 707/E17.045; 707/102

(57) ABSTRACT

A system includes a storage medium having stored instructions thereon that when executed by a machine result in the following: a semantic modeler component to define relationships between data files in a semantic model; a viewer component coupled to the semantic modeler component to view the semantic model; and a packager component coupled to the semantic modeler component to export the semantic model and the data files.

### RELATED APPLICATIONS

This application claims the benefit of U.S. Provisional Application No. 61/052,349 filed May 12, 2008 under 35 U.S.C. §119(e) which application is hereby incorporated herein by reference in its entirety.

### FIELD OF THE INVENTION

The system and techniques described herein relate to grouping and packaging files and more particularly to grouping and packaging files according to semantic models to define and preserve relationships between the files.

### BACKGROUND OF THE INVENTION

As is known in the art, methods exist for collating collections of files into one larger file for packaging and distribution. For example, the taped archive file (TAR) format is both a file format and the name of a program used to handle TAR files. A web application archive (WAR) is an archive file used to distribute a collection of files for a web application. A ZIP file is a file which contains one or more files that have been compressed. A ZIP file format is a file archival format and a data compression format.

Receivers of conventional archived files generally rely upon the file names, extensions, directory structures, and other external information such as readme files or email messages to understand the contents of the file. For example, the receiver can view a ZIP file's contents by viewing directory structure in WinZip®, a utility program for viewing ZIP files. Additionally, the receiver can open the ZIP file's readme file to view file descriptions, instructions on how to install the zipped content, as well as file relationships.

Conventional packing and distribution formats do not provide semantic relationship information for a packaged format. It would be useful, therefore, to provide systems and techniques to define and preserve semantic relationships for multiple pieces of information in a packaged format. In particular, it would be useful to provide semantic models with the packaged files to define and preserve relationships for the files.

### SUMMARY

A semantic packager includes a software tool and method used to group individual files into a single archival file along with an ontology providing a semantic context for the files individually and collectively. The ontology describes a set of concepts and relationships for the files and permits the packaged files to be queried, for example, using the SPARQL query language. A web ontology language (OWL) may be used for authoring the ontology using a semantic model. The semantic model can provide compatibility with a resource description framework (RDF) schema and serialized using RDF and extensible markup language (XML) syntax.

The semantic packager software tool packages and/or distributes and/or stores a semantic model to define and preserve relationships and properties of diverse pieces of information, including packaged files and information therein. In one embodiment, the semantic packager incorporates the semantic model within archived files, for example archived files in a ZIP file. In the same or different embodiment, the semantic packager defines a semantic model associated with multiple archives, thereby avoiding file name conflicts and eliminating directory dependency structures. Also, more than one semantic model can be merged to provide more comprehensive and richer semantic information without loss of information and avoiding information overload.

The semantic model of the semantic packager enables a user to search and filter packaged files using semantic relationships and provides a context to trigger an appropriate action associated with the packaged file. Furthermore, the packaged information can be queried using, for example, SPARQL to retrieve relevant information, for example, all content associated with a task.

In accordance with an aspect of the invention described herein, a system includes a storage medium having stored instructions thereon that when executed by a machine result in a semantic modeler component to define relationships between data files in a semantic model, a viewer component coupled to the semantic modeler component to view the semantic model, and a packager component coupled to the semantic modeler component to export the semantic model and the data files.

In further embodiments, the system includes one or more of the following features: the data files are at least one of text files, image files, audio files, or video files; the semantic model includes at least two data file nodes, each of the data file nodes associated with one of the data files, and at least one data file relationship between the data file nodes, and the viewer component includes a data file viewer to view data files, a model viewer to view the semantic model, and a relationship builder to define data file relationships between the data files in the semantic model; the model viewer includes text fields associated with the data file nodes and lines associated with data file relationships, the lines connecting text fields to represent the semantic model, and the data file viewer includes a directory tree structure to list the data files; the semantic model includes at least two data file nodes, each of the data file nodes associated with one of the data files, and at least one data file relationship between the data file nodes, and the viewer component includes a data file viewer to list and select the data files, and a model builder to define and view the semantic model, the model builder having text areas to represent data file nodes and lines connecting the text areas to represent the data file relationships between the data file nodes; each relationship is associated with an attribute to describe a relation between at least two of the data files; the packager component is configured to export the semantic model and the data files into a file; and the packager component is further configured to import the file.

In another aspect, a method includes defining relationships between data files in a semantic model, and exporting the semantic model and the data files as a package.

In further embodiments, the method includes one or more of the following features: the semantic model includes at least two data file nodes, each data file node associated with one of the data files, and at least one data file relationship between the at least two data file nodes, and further including importing the data files, defining the semantic model by associating the data files with the at least two data file nodes, and defining the at least one data file relationship; importing the data files, listing the data files in a data file viewer, dragging and dropping the data files from the data viewer to a model builder interface, and defining the semantic model in the model builder interface, wherein the semantic model includes at least two data files nodes, each data file node associated with one of the data files, and at least one data file relationship between the at least two data file nodes, and the model builder interface includes text areas representing the data file nodes and lines representing the data file relationships; and exporting further includes storing the semantic model and the data files in a file.

### BRIEF DESCRIPTION OF THE DRAWINGS

The foregoing features of the invention described herein may be more fully understood from the following description of the drawings in which:

FIG. 1 is a block diagram of an environment for implementing the systems, concepts, and techniques described herein;

FIG. 2 is a block diagram of a semantic packager tool;

FIG. 3 is a graph of interconnected objects of a semantic model;

FIG. 4 is a diagram of an embodiment of the viewer of FIG. 2;

FIG. 5 is a diagram of another embodiment of the viewer of FIG. 2;

FIG. 6 is a diagram of an exemplary embodiment of a file structure within a file adapted to be imported or exported by a packager; and

FIG. 7 is flow diagram of an embodiment of a method for practicing the system, techniques, and concepts described herein.

### DETAILED DESCRIPTION

In general overview, the system and methods described herein (collectively and generally sometimes referred to herein as a “semantic packager”) can be used to group files and other content and to define and preserve relationships for the content in a semantic model. A semantic model is defined as a user-centered view of information related to a context, for example, data files related to the financials of a company, and the relationships which exist between different pieces of the information, for example, relationships between financial data files. The semantic model uses language, terms, or expressions to conceptualize relationships for pieces of the information. For example, one or more data files may describe the financial needs of Company XYZ. In particular, a first data file may describe the “Fiscal needs over year 2005”, and a second data file may describe the “Fiscal unmet needs over year 2005” for Company XYZ. A relationship describes the conceptual connection between first and second data files, for example, “Second data file includes the unmet portion of the needs included in the first data file over year 2005”.

In an exemplary application of the systems and techniques described herein, users import files into the semantic packager and define relationships between the files to create semantic models of the relationships between the files. Users also define associations between files and enter descriptions of the relationships. One way users can define such associations is to select imported files from file lists and enter relationship descriptions in a text box to define at least part of the associations. Alternatively, users can use a graphical user interface to drag and drop iconic representations of files into an interactive display area, define links between the iconic representations, and enter descriptions for the links.

Users can save semantic models in a file. The file can have a distinct file extension, for example, ‘.SPA’, to designate a semantic packager archive. The file can be shared with other users who may import the file.

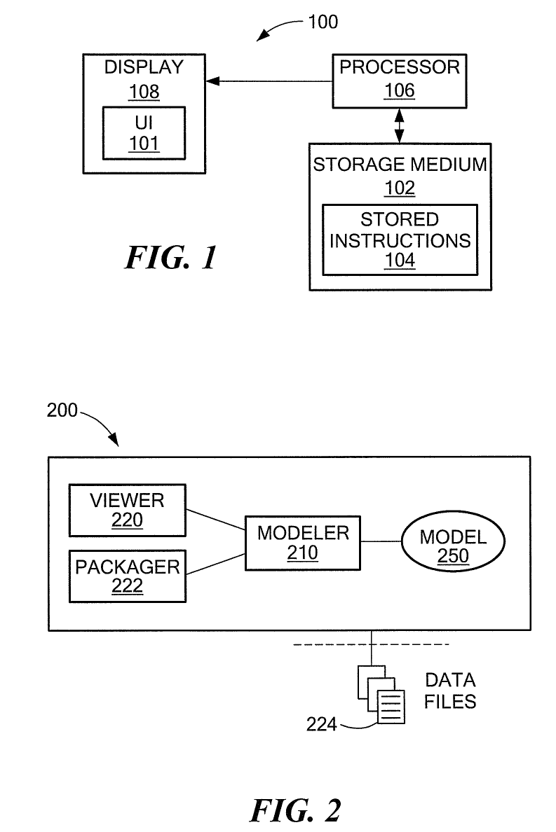

Referring now to FIG. 1, a computer system 100 for implementing a semantic packager includes a storage medium 102 for storing instructions 104. The storage medium 102 can be a computer memory, for example, a data disk, random-access memory or read-only memory. The stored instructions 104 can include software for executing the semantic packager. A processor 106, such as a dual-core processor, loads the stored instructions 104 from the storage medium 102 and executes the stored instructions 104, for example, as a software program. The processor 106 further responds to user input from a user of the system 100. The processor 106 directs output of the software program to a display unit 108, for example, a CRT or other display devices. A windowing system executing on the processor 106, such as Microsoft Windows® from Microsoft Corporation, is capable of converting display commands of the software program into a format acceptable to the display unit 108 which updates a user interface screen 101 displayed on the display unit 108. Other hardware and software components may support the system 100. For example, user input devices such as a mouse and keyboard can be used for accepting user input.

The semantic packager software tool packages and/or distributes and/or stores a semantic model to define and preserve relationships and properties of diverse pieces of information, including packaged files and information therein. In one embodiment, the semantic packager incorporates the semantic model within archived files, for example archived files in a ZIP file. In the same or different embodiment, the semantic packager defines a semantic model associated with multiple archives, thereby avoiding file name conflicts and eliminating directory dependency structures. Also, more than one semantic model can be merged to provide more comprehensive and richer semantic information without loss of information and avoiding information overload.

The semantic model of the semantic packager enables a user to search and filter packaged files using semantic relationships and provides a context to trigger an appropriate action associated with the packaged file. Furthermore, the packaged information can be queried using, for example, SPARQL to retrieve relevant information, for example, all content associated with a task.

Referring now to FIG. 2, in one aspect, a semantic packager 200, which can be loaded from the storage medium and executed on processor similar to the processor described above in conjunction with FIG. 1, includes a modeler component 210 which defines relationships between data files 224 in a model 250. A viewer component 220 is coupled to the modeler component 210 and allows the model 250 to be viewed e.g. on a display unit such as the display unit 108 (FIG. 1). A packager component 222 is coupled to the modeler component 210 to export and package the model 250 and the data files 224.

As will be explained in further detail below, the packager component 222 interacts with the modeler component 210 to collect and store information about model 250 including model nodes, relationships, and instances of the model 250. The packager component 222 also interacts with the modeler component 210 to determine which data files 224 the model 250 references.

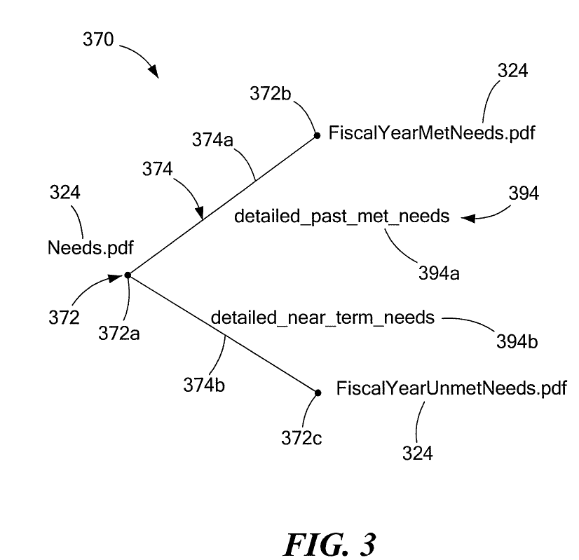

In one embodiment, the packager component 222 includes software instructions for encoding the model 250 in a data structure to represent the model nodes and relationships. The data structure may include class objects to represent model nodes, and class objects to represent model relationships. Still further, the software instructions may process instances of the model 250 and store the instances as data in a data file. Model instances refer to named data files and the relationships between the named data files, as will be explained below with reference to FIG. 3

In the same or different embodiment, the packager component 222 stores the model structure in one portion of a packaged data file, and stores instances of the model in another portion of the packaged data file. Still further, the packager component 222 stores the data files in the packaged data file. The packager component 222 may provide security encryption for safe transport of the packaged data file over a public and/or insecure network, and/or compression to compress the files.

Referring again to FIG. 2, the model 250 conceptualizes relationships between two or more data files 224. The model 250 may be implemented using a variety of programming methods, such as arrays and linked lists stored in memory. The model 250 may be also implemented using object-oriented techniques, for example, by defining class objects for generic data files 224, and subclass objects for specific object file types, including, but not limited to, text and image files. A linkage class object can define a relationship between two or more data file class objects. For example, a first data file class object can be instantiated for a first excel spreadsheet file called “yearly_report.xls” and a second data file class object can be instantiated for a second excel spreadsheet file called “monthly_report.xls.” A single linkage class object can be instantiated to include a reference to the first and second instantiated data file class objects. The instantiated linkage class object can include attributes describing the relationship between the first and second excel files. For example, an attribute may be the text string “monthly_report.xls is a detailed view of month X in yearly_report.xls”.

In one embodiment, the modeler component 210, viewer component 220, and the packager component 222 are implemented as one or more software modules including software instructions stored on a storage medium, such as that described in conjunction with FIG. 1. The software instructions can be written in a programming language such as C++ or Java, and developed using an Integrated Development Environment (IDE) or a command line interface. The software instructions may be separated into source files which with the assistance of the IDE can be modified, debugged, and compiled into one or more executable programs or shared libraries.

The software instructions may be compiled into a standalone executable program which can be loaded and executed on a machine, for example, a computer. Alternatively, the software may be downloaded as a service over a network, such as an intranet or the Internet, or loaded as a dynamically linked library in an operating system to be used by other software applications.

In a further embodiment, the data files 224 include text files, image files, audio files, video files, etc. or any combination thereof. The data files 224, however, are not limited to these data file types and can include any data file type represented with any data file format (such as the PDF format).

The modeler component 210 defines the relationships used in the model 250 and can perform other functions such as communicating with the viewer component 220 and the packager component 222 to update and export the model 250 in a packaged data file for use with other applications. Using the above example of the model 250 implemented using a class object hierarchy, the modeler component 210 can include software instructions for defining and executing the class object hierarchy of the model 250.

Referring now to FIG. 3, in another embodiment, a semantic model 370 includes a plurality of data file nodes 372a-372c. Each of the data file nodes 372a, 372b, 372c is associated with a data file (generally denoted 372), and at least one data file relationship, generally denoted 374. Each of the data file relationships 374 is associated with an attribute, generally denoted 394. An attribute 394 can include, but is not limited to, a textual description, a numerical value, a mathematical expression, or a defined category.

For example, FIG. 3 shows three data files nodes 372a, 372b, 372c for three respective data files: Needs.pdf; FiscalYearMetNeeds.pdf; and FiscalYearUnmetNeeds.pdf. A first data file relationship exists between Needs.pdf and FiscalYearMetNeeds.pdf, as shown by the line designated by reference numeral 374a drawn between nodes 372a and 372b. The first data file relationship 374a is characterized by an attribute 394a, which in this example is a textual description defined by the text string “detailed_past_met_needs.” A second data file relationship exists between Needs.pdf and FiscalYearUnmetNeeds.pdf, as shown by the line designed by reference numeral 374b drawn between nodes 372a and 372c. The second data file relationship 374b is characterized by an attribute 394b, which is a textual description defined by the text field “detailed_past_unmet_needs.” In this way, the semantic model 370 includes the first and second data file relationships 374a, 374b to describe relationships between the overall needs in Needs.pdf, and the respective met and unmet needs in FiscalYearMetNeeds.pdf and FiscalYearUnmetNeeds.pdf.

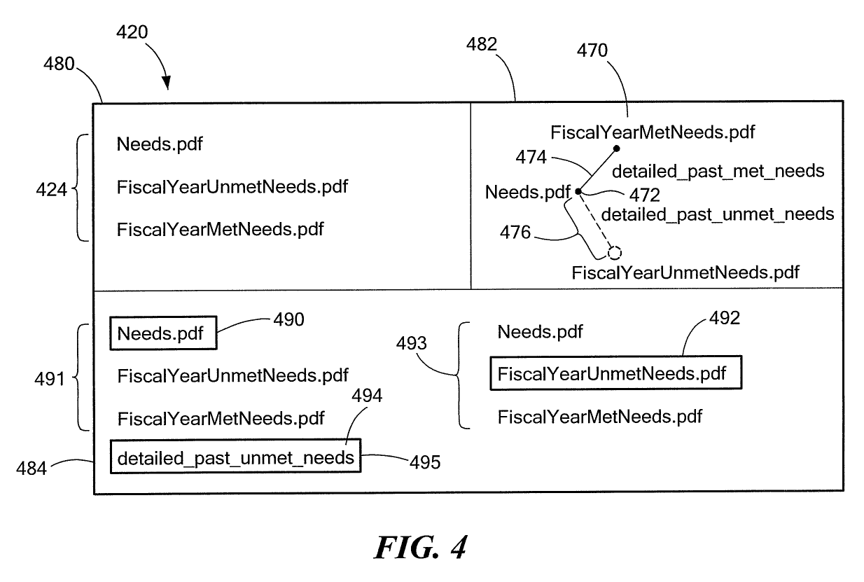

Referring now to FIG. 4, a further embodiment of the systems and techniques includes a viewer component 420 including a data file viewer 480 to view data files 424, a model viewer 482 to view a semantic model 470 as a graphical representation, and a relationship builder 484 to define data file relationships 474 between the data file nodes 472 in the semantic model 470. For example, a new data file relationship (shown as the dotted line and circle together designated by reference numeral 476) can be defined in the relationship builder 484 by selecting two data files 490, 492 in respective data file listings 491, 493 and entering a description of the data file relationship 494 in a text box 495. The new data file relationship 476 can be added to the semantic model 470 using a button (not shown) in the relationship builder 484 to update the semantic model 470 and redisplay the semantic model in the model viewer 482.

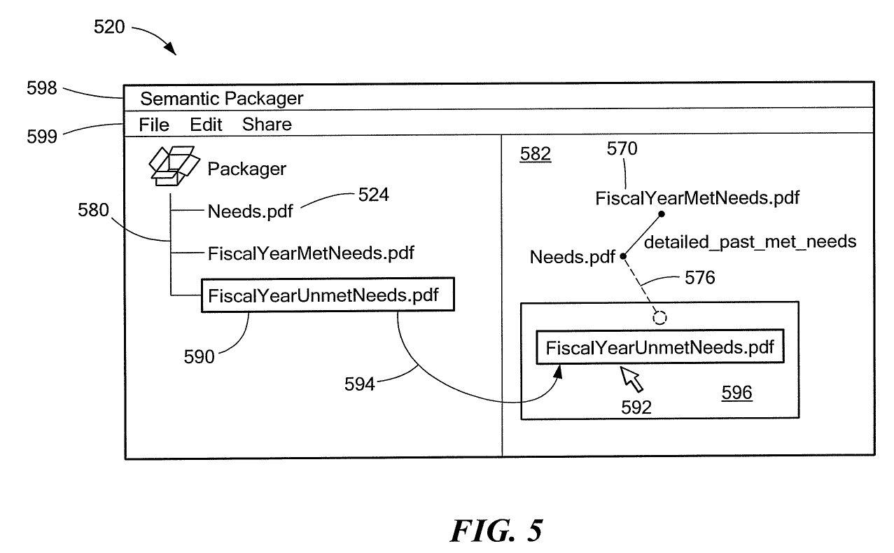

Referring now to FIG. 5, in another embodiment, a viewer component 520 includes a data file viewer 580 to list and select data files 524 and a model builder 582 to define and view a semantic model 570 as a graphical representation. In this embodiment, the semantic model 570 can be defined using direct manipulation of displayed objects in the viewer component 520. For example, an input device (not shown) can be used to control a cursor 592 to select a data file 590 in the data file viewer 580, drag the selected data file (as indicated by the arrow designated by reference numeral 594) to a location 596 in the model builder 582 to indicate a new data file relationship 576 in the semantic model 570, and drop the selected data file at the location 596. In response, a modeler component similar to that described in conjunction with FIG. 2 can rebuild the semantic model 570 and send a command to the viewer component 520 to update the graphical representation of the semantic model 570 in the model builder 582.

The viewer component 520 can include other components including a title bar 598 and a popup menu bar 599 to include other commands.

In another embodiment, a packager, which may be similar to packager 222 described above in conjunction with FIG. 2, is configured to export a semantic model in a packaged file. In a further embodiment, the packager 222 exports data files into the packaged file. The packaged file may be a flat file, for example, a comma-delimited file, and may use a specific file format to store the model. Still further, the packager 222 may import the packaged file.

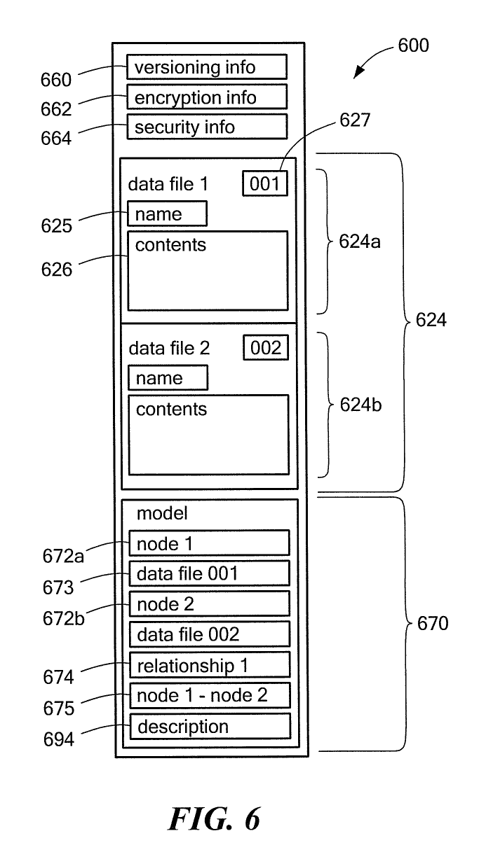

Referring now to FIG. 6, a file 600 adapted to be exported or imported by a semantic packager, as may be similar to semantic packager 200 described in conjunction with FIG. 2, includes versioning information 660, encryption information 662, such as encryption strength, keys, and algorithms, and security information 664, such as an access mode and password. The file 600 can further include a plurality of data files, generally denoted 624. In the exemplary embodiment of FIG. 6, two data files 624a, 624b are shown. Those of ordinary skill in the art will appreciate, of course, that file 600 can include any number of data files 624. Each of the data files 624 includes fields for the data file name (and location) 625, the contents of the data file 626, and a unique data file identification number 627. The contents of the data file 626 can include text for a text file, pixel information for an image file, etc., depending on the type of data content. The data content may be compressed. Alternatively, the file 600 may include a reference, such as a file name and location, to an external archive file, such as a zip file.

The data file 600 also includes a model 670, including the nodes of the model 672a, 672b and the relationships between the nodes 674. Each node 672a, 672b may include a reference 673 to a data file 624, for example by including the unique data file identification number 627 of the data file 624. Furthermore, the relationships 674 may include a set of data file nodes 675 referenced by the relationship 674 and the description of the relationship 694. Those of ordinary skill in the art will appreciate, of course, that file 600 can include any number of nodes and relationships.

Alternatively, the model 670 is saved in a relational database. One advantage of a storing the model 670 in a relational database is that the model 670 can be searched and queried using query languages such as structured query language (SQL).

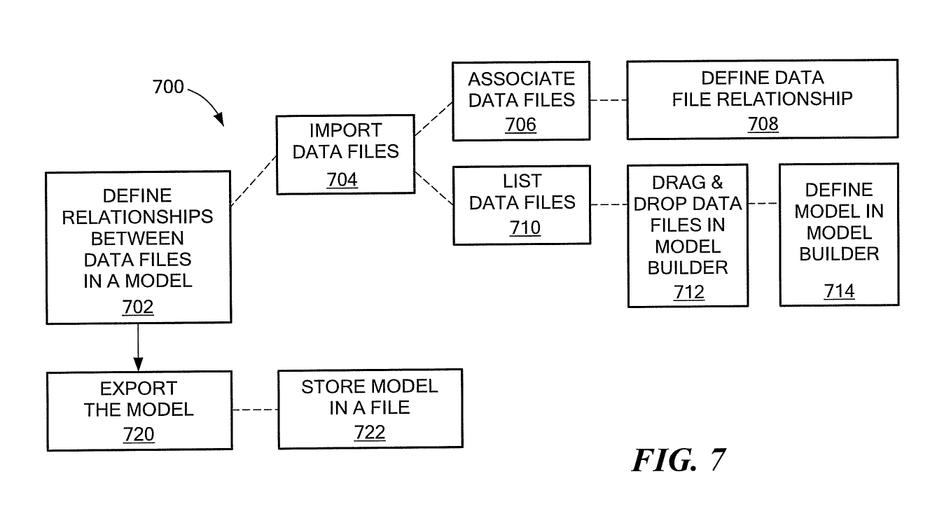

Referring now to FIG. 7, in one aspect, a computer implemented method 700 includes defining relationships between data files in a model 702, and exporting the model and the data files as a package 720. Exporting the model can further include storing the model 722 and, optionally, the data files in a file, as may be similar to file 600 described in conjunction with FIG. 6.

In one embodiment, defining the model 702 includes importing the data files 704, associating the data files 706, and defining relationships between the data files 708. Associating the data files 706 includes defining a link between the data files, whereas defining relationships between the data files 708 includes describing the relationships, such as with a text string.

In another embodiment of the method, importing the data files 704, includes listing the data files in a data file viewer 710, dragging and dropping the data files from the data viewer to a model builder interface 712, and defining the semantic model in the model builder interface 714.

Having described preferred embodiments of the system, techniques, and concepts, scope of protection afforded by this patent will now become apparent to those of ordinary skill in the art that other embodiments incorporating these systems, techniques, and concepts may be used. Accordingly, it is submitted that the scope of protection afforded by this patent should not be limited to the described embodiments but rather should be limited only by the spirit and scope of the appended claims.

1. A system comprising:
a storage medium having stored instructions thereon that when executed by a machine result in the following:
a semantic modeler component to define relationships between data files in a semantic model;
a viewer component coupled to the semantic modeler component to view the semantic model; and
a packager component coupled to the semantic modeler component to export the semantic model and the data files.

2. The system of claim 1 wherein the data files are at least one of text files, image files, audio files, or video files.

3. The system of claim 1 wherein the semantic model comprises at least two data file nodes, each of the data file nodes associated with one of the data files, and at least one data file relationship between the data file nodes, and the viewer component comprises:
a data file viewer to view data files;
a model viewer to view the semantic model; and
a relationship builder to define data file relationships between the data files in the semantic model.

4. The system of claim 3 wherein the model viewer comprises:
text fields associated with the data file nodes and lines associated with data file relationships, the lines connecting text fields to represent the semantic model; and
the data file viewer comprises a directory tree structure to list the data files.

5. The system of claim 1 wherein the semantic model comprises at least two data file nodes, each of the data file nodes associated with one of the data files, and at least one data file relationship between the data file nodes; and the viewer component comprises:
a data file viewer to list and select the data files; and
a model builder to define and view the semantic model, the model builder having text areas to represent data file nodes and lines connecting the text areas to represent the data file relationships between the data file nodes.

6. The system of claim 1 wherein each relationship is associated with an attribute to describe a relation between at least two of the data files.

7. The system of claim 1 wherein the packager component is configured to export the semantic model and the data files into a file.

8. The system of claim 7 wherein the packager component is further configured to import the file.

9. A method comprising:
defining relationships between data files in a semantic model; and
exporting the semantic model and the data files as a package.

10. The method of claim 9 wherein the semantic model comprises:
at least two data file nodes, each data file node associated with one of the data files; and
at least one data file relationship between the at least two data file nodes, and further comprising:
importing the data files; and
defining the semantic model by associating the data files with the at least two data file nodes, and defining the at least one data file relationship.

11. The method of claim 9 further comprising:
importing the data files;
listing the data files in a data file viewer;
dragging and dropping the data files from the data viewer to a model builder interface; and
defining the semantic model in the model builder interface,
wherein the semantic model includes at least two data files nodes, each data file node associated with one of the data files, and at least one data file relationship between the at least two data file nodes, and the model builder interface includes text areas representing the data file nodes and lines representing the data file relationships.

12. The method of claim 9 wherein exporting further comprises storing the semantic model and the data files in a file.
